(19) United States
(12) Patent Application Publication
(10) Pub. No.: US 2017/0360250 A1
(43) Pub. Date: Dec. 21, 2017

(54) BEVERAGE-BREWING DEVICE SYSTEM

(71) Applicant: Scott SPENCER, New York, NY (US)

(72) Inventor: Scott SPENCER, New York, NY (US)

(21) Appl. No.: 15/692,454

(22) Filed: Aug. 31, 2017

Related U.S. Application Data
(63) Continuation of application No. PCT/US2015/018290, filed on Mar. 2, 2015.

(51) Int. Cl. A47J 31/56; A47J 31/04; A47J 31/44; A47J 31/52

(52) U.S. Cl. CPC A47J 31/56; A47J 31/52; A47J 31/04; A47J 31/44

(57) ABSTRACT

A beverage-brewing machine may receive, from an external network via a network-interface device system, a user-request to at least adjust a beverage-brewing parameter. The beverage-brewing machine may adjust the beverage-brewing parameter in accordance with the user-request and instruct a beverage-brewing device system of the beverage-brewing machine to perform a beverage-brew-process in a manner consistent with at least the beverage-brewing parameter adjusted in accordance with the user-request.

### CROSS-REFERENCE TO RELATED APPLICATION

This application is a continuation of prior International Patent Application No. PCT/US2015/018290, filed Mar. 2, 2015, the entire disclosure of which is hereby incorporated herein by reference.

### TECHNICAL FIELD

Aspects of this disclosure generally are related to beverage-brewing device systems and device systems that interact with beverage-brewing device systems.

### BACKGROUND

Conventional beverage-brewing machines typically allow a user to brew a beverage, such as coffee, espresso, cappuccino, tea, or some other hot beverage, by pressing buttons, moving levers, or turning dials on the machine. In addition to causing the brewing of a beverage, such buttons, levers, or dials also allow the user to adjust beverage brewing parameters, such as the size or type of the beverage to be brewed. However, such buttons, levers, and dials limit control of the beverage-brewing machine to a location at the device itself. For at least this reasons, a need in the art exists for improved techniques for controlling a beverage-brewing machine.

### SUMMARY

At least the above-discussed need is addressed and technical solutions are achieved in the art by various embodiments of the present invention. In some embodiments, a beverage-brewing machine including a data processing device system; a beverage-brewing device system communicatively connected to the data processing device system and configured to perform a beverage-brew-process; a beverage-brewing device system communicatively connected to the data processing device system and configured to perform a beverage-brew-process; a network-interface device system communicatively connected to the data processing device system and an external network, the external network being external to the beverage-brewing machine; and a processor-accessible memory device system communicatively connected to the data processing device system and storing a program executable by the data processing device system. The data processing device system may be configured by the program at least to: receive, from the external network via the network-interface device system, a user-request to at least adjust a beverage-brewing parameter; adjust the beverage-brewing parameter in accordance with the user-request; and instruct the beverage-brewing device system to perform the beverage-brew-process in a manner consistent with at least the beverage-brewing parameter adjusted in accordance with the user-request.

In some embodiments, the beverage-brewing parameter is a water temperature, a carafe temperature, a timer setting, or a water flow setting. The water flow setting may be an adjustable water flow rate over time. In some embodiments, the water flow setting is an adjustable pause in water flow. In some embodiments, the water flow setting is an adjustable volume of water to be released by the beverage-brewing device system.

In some embodiments, the user-request is to at least adjust a plurality of beverage-brewing parameters. In some embodiments, the data processing device system is configured by the program at least to: adjust the plurality of beverage-brewing parameters in accordance with the user-request; and instruct the beverage-brewing device system to beverage-brew in a manner consistent with at least the plurality of beverage-brewing parameters adjusted in accordance with the user-request.

The plurality of beverage-brewing parameters may include a water temperature, a carafe temperature, a timer setting, and a water flow setting. The data processing device system may be configured by the program at least to store the plurality of beverage-brewing parameters adjusted in accordance with the user-request in the processor-accessible memory device system as a custom mode associated with a user associated with the user-request.

In some embodiments, the program is or includes a web-server program.

In some embodiments, the beverage-brewing machine further includes a plurality of sensors communicatively connected to the data processing device system. The sensors may be configured to provide sensor-based information about the beverage-brewing device system, and the user-request may indicate a remote user-device from which the user-request originated. In some embodiments, the data processing device system is configured by the program at least to: transmit, via the network-interface device system and the external network, at least some of the sensor-based information to the remote user-device. The at least some of the sensor-based information may indicate whether or not a carafe is properly installed, a water level of a water reservoir, an empty water reservoir, a water temperature, a carafe heater temperature, a last time the beverage-brewing machine was used by a user, or a last time a portion of the beverage-brewing machine was cleaned.

In some embodiments, the user-request indicates a remote user-device. The data processing device system may be configured by the program at least to: determine that the beverage-brewing device system has completed at least a portion of the beverage-brew-process instructed to be performed in the manner consistent with at least the beverage-brewing parameter adjusted in accordance with the user-request; and transmit, via the network-interface device system and the external network, an indication to the remote user-device that the at least the portion of the beverage-brew-process has completed. The user-request may indicate the remote user-device as a device from which the user-request originated. In some embodiments, the indication to the remote user-device is a text message or an e-mail.

In some embodiments, the user-request indicates that a mobile application of a remote and mobile user-device originated the user-request.

In some embodiments, the user-request indicates that a web browser of a user-device originated the user-request.

In some embodiments, a beverage-brewing machine configuration device includes a data processing device system; an input-output device system communicatively connected to the data processing device system; a network-interface device system communicatively connected to the data processing device system and an external network, the external network being external to the beverage-brewing machine configuration device; and a processor-accessible memory device system communicatively connected to the data processing device system and storing a program executable by the data processing device system. The data processing device system may be configured by the program at least to: receive, via the input-output device system, a user-request to at least perform a beverage-brew-process; and instruct, via the network-interface device system and the external network, a beverage-brewing machine to perform the beverage-brew-process.

The data processing device system may be configured by the program at least to: receive, from the beverage-brewing machine via the network-interface device system and the external network, sensor-based information about the beverage-brewing machine. In some embodiments, the input-output device system includes a display device. The data processing device system may be configured by the program at least to present, via the display device, a notification based on the received sensor-based information about the beverage-brewing machine. In some embodiments, the sensor-based information indicates whether or not a carafe is properly installed, a water level of a water reservoir, an empty water reservoir, a water temperature, a carafe heater temperature, a last time the beverage-brewing machine was used by a user, or a last time a portion of the beverage-brewing machine was cleaned.

In some embodiments, the data processing device system is configured by the program at least to receive, from the beverage-brewing machine via the network-interface device system and the external network, an indication that at least a portion of the beverage-brew-process has completed.

The data processing device system may be configured by the program at least to receive, via the input-output device system, a user-indication of a plurality of beverage-brewing parameters at least for the beverage-brewing machine.

In some embodiments, the data processing device system is configured by the program at least to instruct, via the network-interface device system and the external network, the beverage-brewing machine to store the user-indication of the plurality of beverage-brewing parameters or a derivative thereof.

In some embodiments, a particular user is associated with the beverage-brewing machine configuration device, and the data processing device system is configured by the program at least to transmit, via the network-interface device system and the external network, the user-indication of the plurality of beverage-brewing parameters, or a derivative thereof, to at least another beverage-brewing machine configuration device associated with a user previously-approved by the particular user.

In some embodiments, the data processing device system is configured by the program at least to store preferred-parameter information associated with the particular user in the processor-accessible memory device system prior to transmitting the user-indication of the plurality of beverage-brewing parameters, or the derivative thereof, to at least the other beverage-brewing machine configuration device associated with the user previously-approved by the particular user, the preferred-parameter information based on the user-indication of the plurality of beverage-brewing parameters.

In some embodiments, a particular user is associated with the beverage-brewing machine configuration device, and the data processing device system is configured by the program at least to: instruct, via the network-interface device system and the external network, a remote device system to store preferred-parameter information; and instruct, via the network-interface device system and the external network, transmission of at least some of the preferred-parameter information stored by the remote device system to at least another beverage-brewing machine configuration device associated with a user previously-approved by the particular user, wherein the preferred-parameter information is based on the user-indication of the plurality of beverage-brewing parameters.

The beverage-brewing machine configuration device may be a mobile device and the program may be or include a mobile application of the mobile device.

In some embodiments, the data processing device system is configured by the program at least to cause the input-output device system to display a beverage-related advertisement at least when (a) receiving the user-request to at least perform the beverage-brew-process, or (b) instructing, via the network-interface device system and the external network, the beverage-brewing machine to perform the beverage-brew-process.

The beverage-brewing machine may be a coffee-brewing machine.

In some embodiments, a beverage-brewing machine communication device system includes a data processing device system; an input-output device system communicatively connected to the data processing device system; a network-interface device system communicatively connected to the data processing device system and an external network, the external network being external to the beverage-brewing machine communication device; and a processor-accessible memory device system communicatively connected to the data processing device system and storing a program executable by the data processing device system. The data processing device system may be configured by the program at least to: transmit a request, via the network-interface device system, to each of a plurality of beverage-brewing machines; receive, in response to the transmitted requests, respective information from each of the plurality of beverage-brewing machines; generate processed information at least by processing at least some of the respective information received from at least two of the plurality of beverage-brewing machines; and output, via the input-output device system, the processed information or a derivative thereof.

The processing of the at least some of the respective information received from at least two of the plurality of beverage-brewing machines may include aggregating or summarizing the at least some of the respective information received from at least two of the plurality of beverage-brewing machines.

The input-output device system may include a display device, and the output, via the input-output device system, of the processed information may be a display of the processed information via the display device.

Various embodiments of the present invention may include systems, devices, or machines that are or include combinations or subsets of any or all of the systems, devices, or machines and associated features thereof described herein.

Further, all or part of any or all of the systems, devices, or machines discussed herein or combinations or subcombinations thereof may implement or execute all or part of any or all of the methods discussed herein or combinations or subcombinations thereof

For example, in some embodiments, a beverage-brewing method is executed by a beverage brewing machine. The beverage brewing machine may include a data processing device system; a beverage-brewing device system communicatively connected to the data processing device system and configured to perform a beverage-brew-process; a network-interface device system communicatively connected to the data processing device system and an external network, the external network being external to the beverage-brewing machine; and a processor-accessible memory device system communicatively connected to the data processing device system and storing a program executable by the data processing device system. The data processing device system may execute the program to execute the method. In some embodiments, the method includes: receiving, from the external network via the network-interface device system, a user-request to at least adjust a beverage-brewing parameter; adjusting the beverage-brewing parameter in accordance with the user-request; and instructing the beverage-brewing device system to perform the beverage-brew-process in a manner consistent with at least the beverage-brewing parameter adjusted in accordance with the user-request.

For another example, in some embodiments, a beverage-brewing method is executed by a beverage-brewing machine configuration device. The beverage-brewing machine configuration device may include a data processing device system; an input-output device system communicatively connected to the data processing device system; a network-interface device system communicatively connected to the data processing device system and an external network, the external network being external to the beverage-brewing machine configuration device; and a processor-accessible memory device system communicatively connected to the data processing device system and storing a program executable by the data processing device system. The data processing device system may execute the program to execute the method. In some embodiments, the method includes: receiving, via the input-output device system, a user-request to at least perform a beverage-brew-process; and instructing, via the network-interface device system and the external network, a beverage-brewing machine to perform the beverage-brew-process.

For yet another example, in some embodiments, a method is executed by a beverage-brewing machine communication device system. The beverage-brewing machine communication device system may include a data processing device system; an input-output device system communicatively connected to the data processing device system; a network-interface device system communicatively connected to the data processing device system and an external network, the external network being external to the beverage-brewing machine communication device; and a processor-accessible memory device system communicatively connected to the data processing device system and storing a program executable by the data processing device system. The data processing device system may execute the program to execute the method. In some embodiments, the method includes: transmitting a request, via the network-interface device system, to each of a plurality of beverage-brewing machines; receiving, in response to the transmitted requests, respective information from each of the plurality of beverage-brewing machines; generating processed information at least by processing at least some of the respective information received from at least two of the plurality of beverage-brewing machines; and outputting, via the input-output device system, the processed information or a derivative thereof

Any of the features of all or part of any or all of the methods discussed herein may be combined with any of the other features of all or part of any or all of the methods discussed in herein. In addition, a computer program product may be provided that comprises program code portions for performing some or all of any of the methods and associated features thereof described herein, when the computer program product is executed by a computer or other computing device or device system. Such a computer program product may be stored on one or more computer-readable storage mediums, also referred to as one or more computer-readable data storage mediums.

For example, in some embodiments, a computer-readable data storage medium system comprises one or more computer-readable data storage mediums storing a program executable by one or more communicatively connected data processing devices of a data processing device system of a beverage-brewing machine. The beverage-brewing machine may further include a beverage-brewing device system communicatively connected to the data processing device system and configured to perform a beverage-brew-process; and a network-interface device system communicatively connected to the data processing device system and an external network, the external network being external to the beverage-brewing machine. The program may include: receiving instructions configured to receive, from the external network via the network-interface device system, a user-request to at least adjust a beverage-brewing parameter; adjusting instructions configured to adjust the beverage-brewing parameter in accordance with the user-request; and instructing instructions configured to instruct the beverage-brewing device system to perform the beverage-brew-process in a manner consistent with at least the beverage-brewing parameter adjusted in accordance with the user-request.

For another example, in some embodiments, a computer-readable data storage medium system comprises one or more computer-readable data storage mediums storing a program executable by one or more communicatively connected data processing devices of a data processing device system of a beverage-brewing machine configuration device. The beverage-brewing machine configuration device may further include an input-output device system communicatively connected to the data processing device system; and a network-interface device system communicatively connected to the data processing device system and an external network, the external network being external to the beverage-brewing machine configuration device. The program may include: receiving instructions configured to receive, via the input-output device system, a user-request to at least perform a beverage-brew-process; and instructing instructions configured to instruct, via the network-interface device system and the external network, a beverage-brewing machine to perform the beverage-brew-process.

For yet example, in some embodiments, a computer-readable data storage medium system comprises one or more computer-readable data storage mediums storing a program executable by one or more communicatively connected data processing devices of a data processing device system of a beverage-brewing machine communication device system. The beverage-brewing machine communication device system may further include an input-output device system communicatively connected to the data processing device system; and a network-interface device system communicatively connected to the data processing device system and an external network, the external network being external to the beverage-brewing machine communication device. The program may include: transmitting instructions configured to transmit a request, via the network-interface device system, to each of a plurality of beverage-brewing machines; receiving instructions configured to receive, in response to the transmitted requests, respective information from each of the plurality of beverage-brewing machines; generating instructions configured to generate processed information at least by processing at least some of the respective information received from at least two of the plurality of beverage-brewing machines; and outputting instructions configured to output, via the input-output device system, the processed information or a derivative thereof.

In some embodiments, each of any or all of the computer-readable data storage medium systems (also referred to as processor-accessible memory device systems) described herein is a non-transitory computer-readable (or processor-accessible) data storage medium system (or memory device system) including one or more non-transitory computer-readable (or processor-accessible) storage mediums (or memory devices) storing the respective program(s).

Further, any or all of the methods and associated features thereof discussed herein may be implemented or executed by all or part of a device system, apparatus, or machine, such as all or a part of any of the systems, apparatuses, or machines described herein or a combination or subcombination thereof.

### BRIEF DESCRIPTION OF THE DRAWINGS

It is to be understood that the attached drawings are for purposes of illustrating aspects of various embodiments and may include elements that are not to scale. It is noted that like reference characters in different figures refer to the same objects. For example, reference character 302 in each of FIGS. 3-5 refer to the same display, according to some embodiments.

FIG. 1 illustrates a beverage-brewing device system, according to some embodiments of the present invention;

FIG. 2 illustrates some particular versions of the system of FIG. 1, according to some embodiments of the present invention;

FIG. 3 illustrates a user-interface of a device that communicatively connects to a beverage-brewing machine at some time, according to some embodiments of the present invention;

FIG. 4 illustrates another user-interface of a device that communicatively connects to a beverage-brewing machine at some time, according to some embodiments of the present invention;

FIG. 5 illustrates yet another user-interface of a device that communicatively connects to a beverage-brewing machine at some time, according to some embodiments of the present invention;

FIG. 6 illustrates a method executed by a beverage-brewing machine, according to some embodiments of the present invention;

FIG. 7 illustrates a method executed by a device that communicatively connects to a beverage-brewing machine at some time, according to some embodiments of the present invention; and

FIG. 8 illustrates a method executed by a device that communicatively connects to a beverage-brewing machine at some time, according to some embodiments of the present invention.

### DETAILED DESCRIPTION

At least some embodiments of the present invention improve upon control mechanisms of one or more beverage-brewing machines. In some embodiments, initiation of a beverage-brewing process and the setting of parameters for such beverage-brewing process occurs via a user-interface of a device that is remote from the respective beverage-brewing machine and communicatively connected thereto via a network. In some embodiments, the respective beverage-brewing machine provides sensor-based information, such as status updates of one or more components of the respective beverage-brewing machine, to the remote device. Such sensor-based information may be presented to the user at the remote device to further facilitate control of the beverage-brewing machine. In some embodiments, the respective beverage-brewing machine, the remote device, or both, allow(s) the user to store custom sets of beverage-brewing parameters, so individual users can quickly brew different beverages just the way they like. In some embodiments, a user can share one or more of his or her custom sets of beverage-brewing parameters with a friend, so the friend can try a beverage brewed by the friend's beverage-brewing machine according to the user's custom set of beverage-brewing parameters. In some embodiments, a data aggregation device system aggregates data from multiple beverage-brewing machines via a communicative connection and presents such aggregated data to a user. Such aggregated data may be particularly useful to a person of a company that operates, sells, or manufactures many of the beverage-brewing machines, such aggregated data providing insight into the usage and performance of such beverage-brewing machines. It should be notes that the invention is not limited to these or any other examples provided herein, which are referred to for purposes of illustration only.

In this regard, in the descriptions herein, certain specific details are set forth in order to provide a thorough understanding of various embodiments of the invention. However, one skilled in the art will understand that the invention may be practiced at a more general level without these details. In other instances, well-known structures have not been shown or described in detail to avoid unnecessarily obscuring descriptions of various embodiments of the invention.

Any reference throughout this specification to “one embodiment” or “an embodiment” or “an example embodiment” or “an illustrated embodiment” or “a particular embodiment” and the like means that a particular feature, structure or characteristic described in connection with the embodiment is included in at least one embodiment. Thus, any appearance of the phrase “in one embodiment” or “in an embodiment” or “in an example embodiment” or “in this illustrated embodiment” or “in this particular embodiment” or the like in this specification is not necessarily all referring to one embodiment or a same embodiment. Furthermore, the particular features, structures or characteristics of different embodiments may be combined in any suitable manner to form one or more other embodiments.

Unless otherwise explicitly noted or required by context, the word “or” is used in this disclosure in a non-exclusive sense. In addition, unless otherwise explicitly noted or required by context, the word “set” is intended to mean one or more, and the word “subset” is intended to mean a set having the same or fewer elements of those present in the subset's parent or superset.

Further, the phrase “at least” is used herein at times merely to emphasize the possibility that other elements may exist besides those explicitly listed. However, unless otherwise explicitly noted (such as by the use of the term “only”) or required by context, non-usage herein of the phrase “at least” nonetheless includes the possibility that other elements may exist besides those explicitly listed. For example, the phrase, ‘based at least on A’ includes A as well as the possibility of one or more other additional elements besides A. In the same manner, the phrase, ‘based on A’ includes A, as well as the possibility of one or more other additional elements besides A. However, the phrase, ‘based only on A’ includes only A. Similarly, the phrase ‘configured at least to A’ includes a configuration to perform A, as well as the possibility of one or more other additional actions besides A. In the same manner, the phrase ‘configure to A’ includes a configuration to perform A, as well as the possibility of one or more other additional actions besides A. However, the phrase, ‘configured only to A’ means a configuration to perform only A.

The phrase “derivative thereof” and the like is used herein at times in the context of a derivative of data or information merely to emphasize the possibility that such data or information may be modified or subject to one or more operations. For example, if a device generates first data for display, the process of converting the generated first data into a format capable of being displayed may alter the first data. This altered form of the first data may be considered a derivative of the first data. For instance, the first data may be a one-dimensional array of numbers, but the display of the first data may be a color-coded bar chart representing the numbers in the array. For another example, if the above-mentioned first data is transmitted over a network, the process of converting the first data into a format acceptable for network transmission or understanding by a receiving device may alter the first data. As before, this altered form of the first data may be considered a derivative of the first data. For yet another example, generated first data may undergo a mathematical operation, a scaling, or a combining with other data to generate other data that may be considered derived from the first data. In this regard, it can be seen that data is commonly changing in form or being combined with other data throughout its movement through one or more data processing device systems, and any reference to information or data herein is intended to include these and like changes, regardless of whether or not the phrase “derivative thereof” or the like is used in reference to the information or data. As indicated above, usage of the phrase “or a derivative thereof” or the like merely emphasizes the possibility of such changes. Accordingly, the addition of or deletion of the phrase “or a derivative thereof” or the like should have no impact on the interpretation of the respective data or information. For example, the above-discussed color-coded bar chart may be considered a derivative of the respective first data or may be considered the respective first data itself.

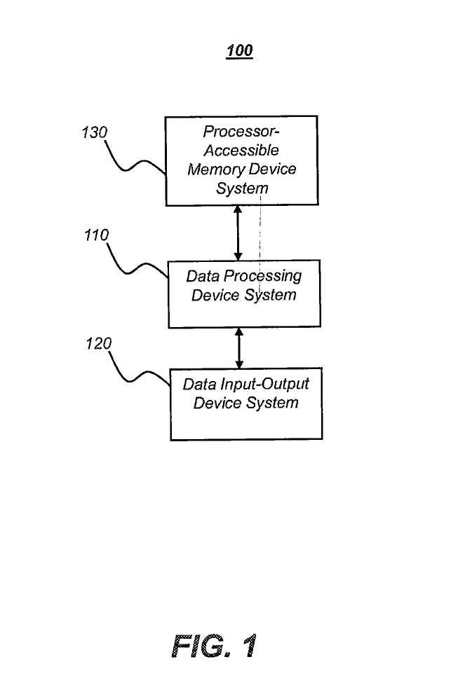

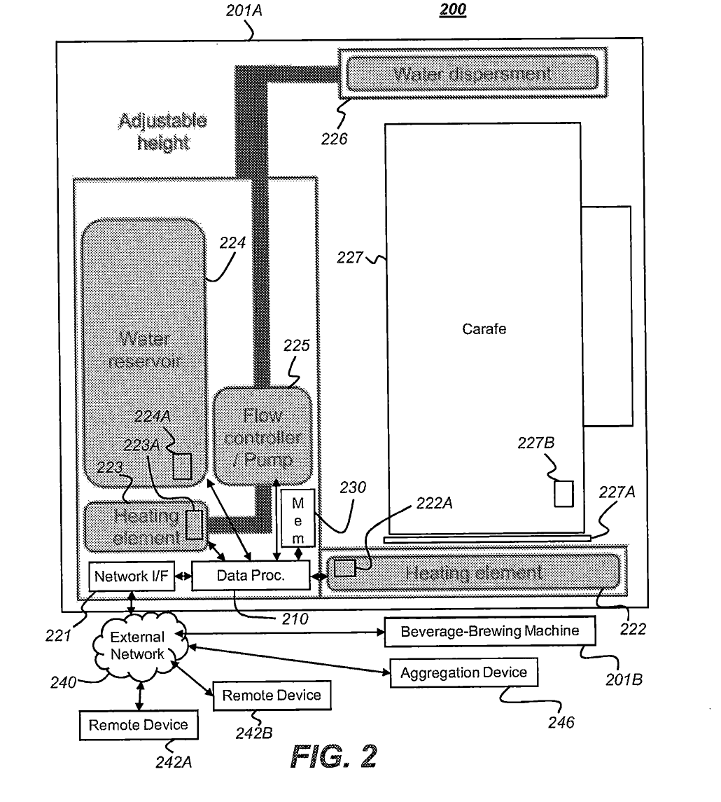

The term “program” in this disclosure should be interpreted as a set of instructions or modules that may be executed by one or more components in a system, such as a controller system or data processing device system, in order to cause the system to perform one or more operations. The set of instructions or modules may be stored by any kind of memory device, such as those described subsequently with respect to the memory device system 130, 230, or both, shown in FIGS. 1 and 2, respectively. In addition, this disclosure may describe or similarly describe that the instructions or modules of a program are configured to cause the performance of an action. The phrase “configured to” in this context is intended to include at least (a) instructions or modules that are presently in a form executable by one or more data processing devices to cause performance of the action (e.g., in the case where the instructions or modules are in a compiled and unencrypted form ready for execution), and (b) instructions or modules that are presently in a form not executable by the one or more data processing devices, but could be translated into the form executable by the one or more data processing devices to cause performance of the action (e.g., in the case where the instructions or modules are encrypted in a non-executable manner, but through performance of a decryption process, would be translated into a form ready for execution). The word “module” may be defined as a set of instructions. Such descriptions should be deemed to be equivalent to describing that the instructions or modules are configured to cause the performance of the function.

The word “device”, the word “machine”, and the phrase “device system” all are intended to include one or more physical devices or sub-devices (e.g., pieces of equipment) that interact to perform one or more functions, regardless of whether such devices or sub-devices are located within a same housing or different housings. However, it may be explicitly specified that a device or machine or device system reside entirely within a same housing to exclude embodiments where the respective device, machine, or device system reside across different housings. The word “device” may equivalently be referred to as a “device system”.

Further, the phrase “in response to” may be used in this disclosure. For example, this phrase might be used in the following context, where an event A occurs in response to the occurrence of an event B. In this regard, such phrase includes, for example, that at least the occurrence of the event B causes or triggers the event A.

FIG. 1 schematically illustrates a beverage-brewing device system 100, according to some embodiments of the present invention. The system 100 may include a data processing device system 110, an input-output device system 120, and a processor-accessible memory device system 130. The processor-accessible memory device system 130 and the input-output device system 120 are communicatively connected to the data processing device system 110.

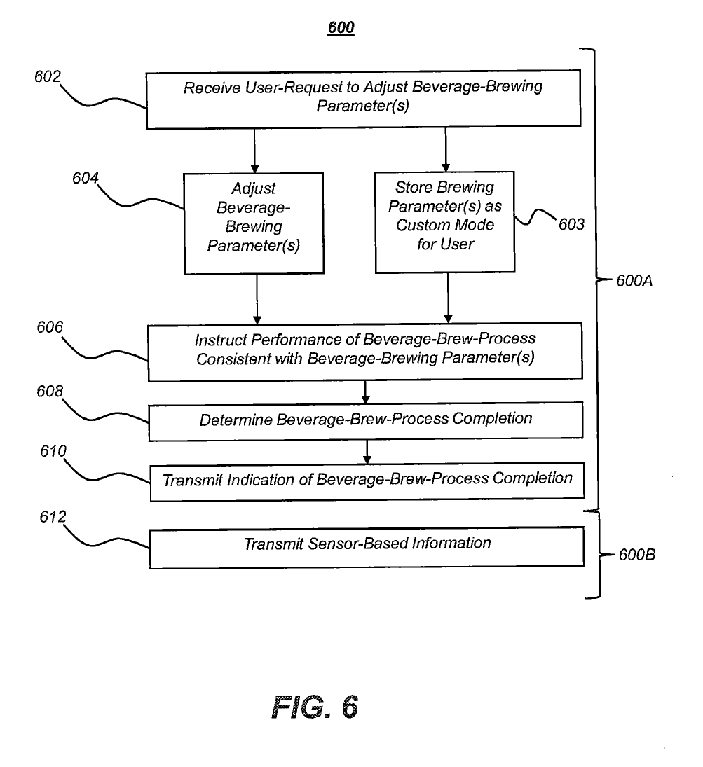

The data processing device system 110 may include one or more data processing devices that implement or execute, in conjunction with other devices, such as those in the system 100, methods of various embodiments of the present invention, including the example methods of FIGS. 6, 7, and 8 described herein. Each of the phrases “data processing device”, “data processor”, “processor”, and “computer” and the like is intended to include any data processing device, such as a central processing unit (“CPU”), a desktop computer, a laptop computer, a mainframe computer, a tablet computer such as an iPad (Trademark Apple Inc., Cupertino California), a personal digital assistant, a cellular phone, a smartphone, or any other device for processing data, managing data, or handling data, whether implemented with electrical, magnetic, optical, biological components, or otherwise.

The memory device system 130 includes one or more processor-accessible memory devices configured to store program instructions and other information, including the information and program instructions needed to execute the methods of various embodiments, including the example methods of FIGS. 6, 7, and 8 described herein. In this regard, each of the steps illustrated in the example methods of FIGS. 6, 7, and 8 may represent program instructions stored in the memory device system 130 and configured to cause execution of the respective step. The memory device system 130 may be a distributed processor-accessible memory device system including multiple processor-accessible memory devices communicatively connected to the data processing device system 110 via a plurality of computers and/or devices. On the other hand, the memory device system 130 need not be a distributed processor-accessible memory system and, consequently, may include one or more processor-accessible memory devices located within a single data processing device.

Each of the phrases “processor-accessible memory” and “processor-accessible memory device” and the like is intended to include any processor-accessible data storage device or medium, whether volatile or nonvolatile, electronic, magnetic, optical, or otherwise, including but not limited to, registers, floppy disks, hard disks, Compact Discs, DVDs, flash memories, ROMs, and RAMS. In some embodiments, each of the phrases “processor-accessible memory” and “processor-accessible memory device” is intended to include or be a processor-accessible (or computer-readable) data storage medium. In some embodiments, each of the phrases “processor-accessible memory” and “processor-accessible memory device” is intended to include or be a non-transitory processor-accessible (or computer-readable) data storage medium. In some embodiments, the memory device system 130 may be considered to include or be a non-transitory processor-accessible (or computer-readable) data storage medium system. And, in some embodiments, the memory device system 130 may be considered to include or be a non-transitory processor-accessible (or computer-readable) storage medium system or data storage medium system including or consisting of one or more non-transitory processor-accessible (or computer-readable) storage or data storage mediums.

The phrase “communicatively connected” is intended to include any type of connection, whether wired or wireless, between devices, data processors, or programs in which data may be communicated. Further, the phrase “communicatively connected” is intended to include a connection between devices or programs within a single data processor, a connection between devices or programs located in different data processors, and a connection between devices not located in data processors at all. In this regard, although the memory device system 130 is shown separately from the data processing device system 110 and the input-output device system 120, one skilled in the art will appreciate that the memory device system 130 may be located completely or partially within the data processing device system 110 or the input-output device system 120. Further in this regard, although the input-output device system 120 is shown separately from the data processing device system 110 and the memory device system 130, one skilled in the art will appreciate that such system may be located completely or partially within the data processing system 110 or the memory device system 130, depending on the contents of the input-output device system 120. Further still, the data processing device system 110, the input-output device system 120, and the memory device system 130 may be located entirely within the same device or housing or may be separately located, but communicatively connected, among different devices or housings. In the case where the data processing device system 110, the input-output device system 120, and the memory device system 130 are located within the same device, the system 100 of FIG. 1 may be implemented by a single application-specific integrated circuit (ASIC) in some embodiments.

The input-output device system 120 may include a mouse, a keyboard, a touch screen, a computer, a processor-accessible memory device, a network-interface-card or network-interface circuitry, or any device or combination of devices from which a desired selection, desired information, instructions, or any other data is input to the data processing device system 110. The input-output device system 120 may include a user-activatable control system that is responsive to a user action. The input-output device system 120 may include any suitable interface for receiving a selection, information, instructions, or any other data from other devices or systems described in various ones of the embodiments.

The input-output device system 120 also may include an image generating device system, a display device system, a computer, a processor-accessible memory device, a network-interface-card or network-interface circuitry, or any device or combination of devices to which information, instructions, or any other data is output by the data processing device system 110. The input-output device system 120 may include any suitable interface for outputting information, instructions, or data to other devices and systems described in various ones of the embodiments. If the input-output device system 120 includes a processor-accessible memory device, such memory device may or may not form part or all of the memory device system 130.

According to some embodiments of the present invention, the system 100 includes some or all of the beverage-brewing device system 200 shown in FIG. 2, or vice versa. In this regard, FIG. 2 illustrates a system 200, according to some embodiments of the present invention. The system 200, may be a particular implementation of the system 100, according to some embodiments. The system 200 may include one or more beverage-brewing machines (two shown in FIG. 2, for example, with reference characters 201A, 201B), one or more external networks (one shown in FIG. 2, for example, with reference character 240), one or more beverage-brewing machine configuration devices (two shown in FIG. 2, for example, as remote devices 242A, 242B), and one or more aggregation devices (one shown in FIG. 2, for example, with reference 246). In this regard, the one or more beverage-brewing machines (e.g., 201A, 201B), the one or more beverage-brewing machine configuration devices (e.g., 242A, 242B), and the one or more aggregation device 246 may be communicatively connected to each other via the external network 240 (which may be the Internet or any other data communication network known in the art). In embodiments where multiple external networks exists, subsets of the one or more beverage-brewing machines (e.g., 201A, 201B), the one or more beverage-brewing machine configuration devices (e.g., 242A, 242B), and the one or more aggregation device 246 may be communicatively connected to each other via respective ones of the multiple external networks. Each of the beverage-brewing machines (e.g., 201A, 201B), the beverage-brewing machine configuration devices (e.g., 242A, 242B), and the aggregation device 246 may represent a particular implementation of the system 100, according to some embodiments.

In some embodiments, the beverage-brewing machine 201A is a coffee-brewing machine, although the beverage-brewing machine 201A may be configured to brew other beverages or other beverages in addition to coffee, such as espresso-based or tea-based beverages. In some embodiments, the beverage-brewing machine 201A includes a data processing device system 210 communicatively connected to a processor-accessible memory device system 230. The data processing device system 210 may correspond to at least part of the data processing device system 110, and the memory device system 230 may correspond to at least part of the memory device system 130. The data processing device system 210 may also be communicatively connected to a network-interface device system 221 (which may be or include a network interface card or network interface circuitry, known in the art, for connecting network 240 via wired connection, wireless connection, or both), a carafe heating element 222 (and a temperature sensor 222A therefor), a water heating element 223 (and a temperature sensor 223A therefor, which may directly or indirectly measure temperature of water heated by the water heating element 223), a water volume sensor 224A configured to monitor the water volume in water reservoir 224, a water flow controller and pump 225, a carafe placement sensor 227A configured to monitor proper installation of the carafe 227, and a carafe beverage temperature sensor 227B.

The carafe beverage temperature sensor 227B may be located on an interior of the carafe 227 and may be particularly suited as a device configured to wirelessly connect to the data processing device 210, possibly with its own power source, such as a battery located in the carafe 227. Alternatively, or in addition, the carafe beverage temperature sensor 227B may be formed as part of or reside in or on the carafe placement sensor 227A to indirectly measure the temperature of the beverage within carafe 227 by measuring an exterior temperature of the carafe 227. Such an arrangement may be suitable for applications where wireless connection between the carafe beverage temperature sensor 227B and the data processing device system 210, and where a separate power source for temperature sensor 227B, are not preferred or acceptable.

At least the network-interface device system 221, the carafe heating element 222 (and the temperature sensor 222A therefor), the water heating element 223 (and the temperature sensor 223A therefor), the water volume sensor 224A, and the water flow controller and pump 225, the carafe placement sensor 227A, and the carafe beverage temperature sensor 227B, or a subset of these devices, may correspond to at least part of the data input-output device system 120. In some embodiments, at least the carafe heating element 222 (and the temperature sensor 222A therefor), the water heating element 223 (and the temperature sensor 223A therefor), the water volume sensor 224A, the water flow controller and pump 225, the carafe placement sensor 227A, the carafe beverage temperature sensor 227B, and the water dispersment device 226, or a subset of these devices, may be considered at least part of a beverage-brewing device system configured to perform a beverage-brew-process. In some embodiments, all of the components of beverage-brewing machine 201A reside within a same housing, as illustrated by the rectangular box to which reference 201A points. Similarly, in some embodiments, all of the components of one or more of each other device in system 200 (e.g., 242A, 242B, 201B, 246) may reside within a respective housing. The beverage-brewing machine 201B may have the same configuration as that described above for the beverage-brewing machine 201A.

Although FIG. 2 shows particular sensors 222A, 223A, 224A, and 227A and other devices and locations thereof, the invention is not limited to such particular sensors and devices and locations thereof. Any number of sensors or devices or sensor or device types and locations thereof may be provided, although the specific types and locations described herein may be particularly beneficial in some embodiments. In this regard, the temperature sensor 222A for the carafe heating element 222, the temperature sensor 223A for the water heating element 223, and the water volume sensor 224A may be any applicable sensor or sensors known in the art. The same applies to the carafe placement sensor 227A, which may be a limit switch, known in the art. If it is desired that the temperature of a liquid be monitored, such as the temperature of the water exiting the water dispersment device 226, or the temperature of a beverage in the carafe 227, a sensor such as the TCT resistance thermometer from SICK, Inc. of Minneapolis, Minn., USA, may be used in some embodiments. In some embodiments, the 375 flat heating element from the Watlow Electric Manufacturing Company of St. Louis, Mo., USA may be used as at least part of the carafe heating element 222. In some embodiments, the SeeedStudio Water Flow Sensor (⅛″) from Seeed Technology Limited of Shenzhen, China may be used a water flow sensor for the flow controller/pump 225, and, in some embodiments, the hot sell 6-36V stepper motor small peristaltic pump from Shanghai ZDAN INT. CO., LTD. of Shanghai, China may be used as a pump for the flow controller/pump 225. In some embodiments, the stainless steel electric coffee making heating element from Anhui Ningguo Tiancheng Technology Development Co., Ltd. of Anhui, China may be used as at least part of the heating element 223A.

The data processing device system 210 may be configured by program instructions stored in the memory device system 230 to perform (e.g., cause performance of) a beverage-brewing process. The beverage-brewing process, according to some embodiments, includes causing the heating element 223 to heat water from the water reservoir 224 (e.g., by way of feedback from the water heating element sensor 223A), which is then pumped at a defined flow rate through an adjustable-height water disbursement mechanism 226 (such as an opening at an end of a water passageway) into the carafe 227. Although a carafe 227 is shown in FIG. 2, a mug or other beverage container may be provided instead, according to some embodiments.

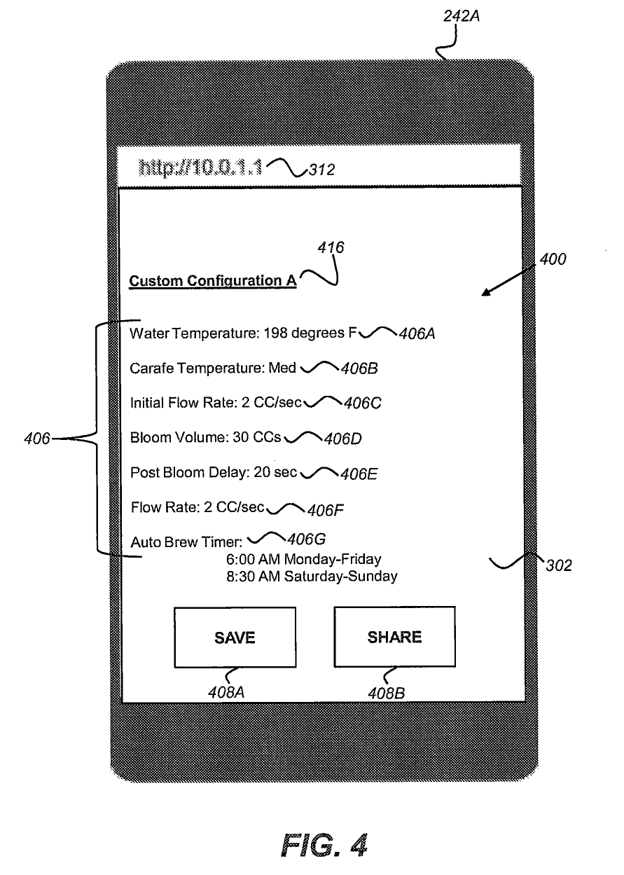

In some embodiments, the data processing device system 210 is configured by a program stored in the memory device system 230 to execute the method 600A (of methods 600, which also includes method 600B, discussed below) in FIG. 6. At step 602, the data processing device system 210 may be configured to receive, from the external network 240 via the network-interface device system 221, a user-request to at least adjust a beverage-brewing parameter. In some embodiments, the user-request is received from a beverage-brewing machine configuration device, such as a remote user-device 242A. The remote device 242A may be a mobile device, such as the user's smart phone, tablet computer, or laptop computer executing a software application (such as an “app”, known in the art; also referred to as a “mobile app” at times, herein) through which the user inputs an updated value for the beverage-brewing parameter, as discussed in more detail below with respect to FIG. 4. The remote device 242A may also be a mobile device or non-mobile device, such as a desktop computer, executing a web browser through which the user inputs the updated value for the beverage-brewing parameter. In this regard, the invention is not limited to any particular hardware or software configuration of the remote device 242A, although implementation of the remote device 242A as a mobile device executing an “app”, known in the art, may be beneficial to provide the user with greater ease of access to and control of the beverage-brewing machine 201A (and also 201B, in some embodiments). In embodiments where the remote device 242A executes a web browser through which the user inputs the updated value for the beverage-brewing parameter, such web browser may interact with a web server executed by the beverage-brewing machine 201A.

FIG. 4 illustrates some embodiments of the present invention where the remote device 242A is a smart phone or tablet computer. In the example of FIG. 4, the remote device 242A includes a display 302 presenting a user interface 400. The user interface 400 presents a set of user-customizable beverage-brewing parameters 406, including a water temperature parameter 406A, a carafe temperature parameter 406B, water flow settings 406C, 406D, 406E, and 406F, and an automatic brewing timer setting 406G.

In some embodiments, the water temperature parameter 406A specifies a temperature at which water is to exit the water dispersment mechanism 226 or a temperature at which the heating element 223 is to heat water from the water reservoir 224 as such water proceeds to the water dispersment mechanism 226 via the flow controller/pump 225. In this regard, the data processing device system 210 may be configured to achieve this specified temperature via feedback from the water heating element sensor 223A.

In some embodiments, the carafe temperature parameter 406B specifies a temperature at which the beverage in the carafe 227 is to be maintained. In this regard, the data processing device system 210 may be configured to maintain this specified temperature via feedback from the carafe beverage temperature sensor 227B.

In some embodiments, the beverage brewing process involves a multi-stage release of water from the water dispersment mechanism 226. In some embodiments, the multi-stages are two stages: a bloom stage followed by a post-bloom stage. The initial bloom stage is an initial release of water with its own associated water flow rate and water volume. The post-bloom stage is a subsequent release of water with its own associated water flow rate and water volume. Typically, the post-bloom stage is longer in duration and water volume than the bloom stage. The parameters shown in FIG. 4 are configured for such a two-stage release of water, although a single-stage or greater-than-two-stage release of water may be used for the beverage brew process. In this regard, one or more user-definable parameters may be provided which allow the user to specify such number of stages.

In the example of FIG. 4, the initial flow rate parameter 406C specifies a water flow rate for the bloom stage, while the bloom volume parameter 406D specifies a volume of water for the bloom stage. Together, the parameters 406C and 406D specify a duration (15 seconds in the example FIG. 4) of the bloom stage. In this regard, the data processing device system 210 may be configured to fulfill parameters 406C and 406D via control of the flow controller/pump 225.

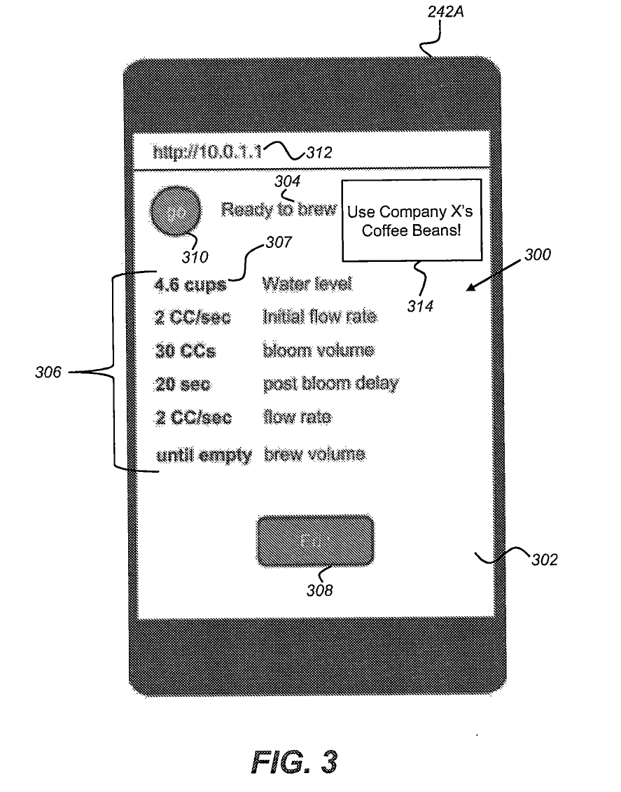

In some embodiments, the post-bloom delay parameter 406E specifies a duration of time between the bloom stage and the post-bloom stage during which water is not released from the water dispersment mechanism 226. In some embodiments, the flow rate parameter 406F specifies a water flow rate during the post-bloom stage. The water volume to be released during the post-bloom stage may be limited by the total volume of the beverage amount to be brewed (e.g., per a ‘brew volume’ parameter like that shown in FIG. 3) minus the volume specified by the bloom volume parameter 406D. In this regard, the data processing device system 210 may be configured to full parameters 406E and 406F via control of the flow controller/pump 225.

In some embodiments, the auto brew timer parameter 406G specifies when the beverage brew process is to automatically be performed (e.g., executed by the data processing device system 210) according to the parameters 406.

It should be noted that each of the initial flow rate parameter 406C and the flow rate parameter 406F is an example of an adjustable water flow rate over time. The post-bloom delay parameter 406E is an example of an adjustable pause in water flow, which may be present between any water-release stage in a multi-stage water release beverage brewing process. The bloom volume parameter 406D is an example of an adjustable volume of water to be released by a beverage-brewing device system. Such an adjustable volume may be specified for any water-release stage in a multi-stage water release beverage brewing process.

It should be noted that the invention is not limited to any particular beverage-brewing parameter, and those illustrated in FIG. 4 represent an example set of parameters that may be beneficial in some embodiments. Further, although the example of FIG. 4 illustrates the set of parameters 406 as a plurality of beverage-brewing parameters, such set of parameters 406 may include one or more beverage-brewing parameters.

In some embodiments, the user may interact with the device 242A to modify the values of any of the beverage-brewing parameters 406. Such interaction may occur using any technique known in the art. For example, the display 302 may be a touch screen display, and the user may contact a screen region associated with a respective one of the parameters 406 (e.g., with the user's finger or a stylus) to select such parameter for editing, and then edit the respective value of the selected parameter by way of a pop-up software keyboard. However, the invention is not limited to any particular manner of editing the parameters 406 or their values.

In some embodiments, the set of beverage-brewing parameters 406 may be grouped as a custom configuration 416 associated with the user (and, optionally, one or more other users) in a custom-parameter mode. In this regard, a plurality of different custom configurations may be provided to allow different sets of beverage-brewing parameters and values thereof to be associated with each user, such that the respective user is provided the opportunity to select different sets of beverage-brewing parameters for different beverage types, brewing styles, or user tastes.

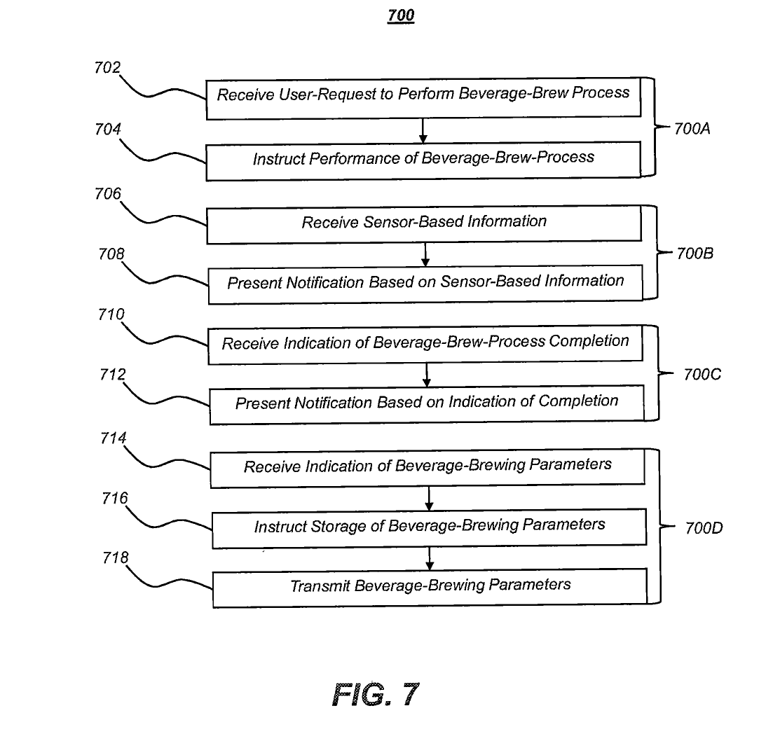

When the user is satisfied with the parameters 406 and their respective values, the user may choose to save the set of parameters 406 by selecting a “save” software button 408A. In some embodiments, the selection of such software button 408A causes the data processing device system (e.g., 110) of the device 242A to begin execution of at least part of a method 700D (of methods 700, which also includes methods 700A, 700B, and 700C, discussed below) in FIG. 7. In particular, in some embodiments, the selection of such software button 408A causes the data processing device system (e.g., 110) of the device 242A to receive, via the input-output device system (e.g., 120, such as via the touchscreen 302, in some embodiments) of the device 242A, a user-indication of the beverage-brewing parameter set 406 (e.g., at least the respective value or values thereof) or a derivative thereof at step 714. In response to receiving this user-indication, the data processing device system of the device 242A may be configured to store the beverage-brewing parameter set 406 (an example of preferred-parameter information, e.g., at least the respective value or values of the beverage-brewing parameter set 406) locally in the processor-accessible memory device system (e.g., 130) of the device 242A, at step 716. Step 716 may also include the data processing device system of the device 242A instructing, via a network-interface device system (e.g., 221, but within device 242A) and the external network 240, the beverage-brewing machine 201A (or some other device system remote from the device 242A) (e.g., by way of network address 312 of the beverage-brewing machine 201A) to store the user-indication of the beverage-brewing parameter set 406 (an example of preferred-parameter information, e.g., at least the respective value or values of the beverage-brewing parameter set 406) or a derivative thereof. Such instruction of the beverage-brewing machine 201A by the remote device 242A may cause the data processing device system 210 of the beverage-brewing machine 201A to receive the user-request to at least adjust one or more beverage-brewing parameters, according to step 602, discussed above. In this regard, in some embodiments, the data processing device system 210 may store the beverage-brewing parameter set 406 (e.g., at least the respective value or values thereof) in the processor-accessible memory device system 230 at step 603 in FIG. 6. In some embodiments of step 603 where the above-discussed custom mode may be implemented, the beverage-brewing parameter set 406 (e.g., at least the respective value or values thereof) may be stored as a particular custom configuration 416 (FIG. 4) associated with at least the user that developed it at the remote device 242A.

Returning to FIG. 4, FIG. 7, and the perspective of the remote device 242A, the user interface 400 may provide a “share” software button 408B, which may be configured to allow a particular user (e.g., of the remote device 242A, the beverage-brewing machine 201A, or both) to share his or her custom configuration 416 with another user. For example, the particular user may have a ‘buddy’ or ‘friend’ list, known in the art, of other users previously-approved by the particular user (e.g., by way of accepted “friend requests”, known in the art). In this regard, at step 718, in some embodiments, the particular user's selection of the “share” software button 408B may cause the data processing device system (e.g., 110) of the device 242A to transmit, via a network-interface device system (e.g., 221, but within device 242A) and the external network 240, an indication of the particular user's defined value or values of the beverage-brewing parameter set 406, or a derivative thereof, to at least another beverage-brewing machine configuration device (e.g., remote device 242B in FIG. 2) associated with at least one of the other users previously approved by the particular user (e.g., one or more other users on the particular user's ‘buddy’ or ‘friend’ list). Although this example incorporates previously-approved other users, e.g., on a ‘buddy’ or ‘friend’ list, such is not required, and the particular user may instead be allowed to transmit the value or values of his or her beverage-brewing parameter set 406 to any user of his or her choosing, according to some embodiments. As shown in FIG. 7, the transmission of the user-indication of the beverage-brewing parameter set 406 or a derivative thereof at step 718 may occur after the storage of the beverage-brewing parameter set 406 (an example of preferred-parameter information) or a derivative thereof, either locally at the device 242A or at a device system remote from the device 242A (e.g., the beverage-brewing machine 201A), at step 716. However, step 718 may occur independently from an embodiment of step 716, in some embodiments of the present invention.

An advantage of sharing a first user's parameter set 406 with another user (e.g., by way of share button 408B) is that the first user may discover a particular set of parameter values that brews a particularly enjoyable beverage, and the first user may be able to efficiently share such parameter values with friends or family members.

Upon the user's adjustment of one or more beverage-brewing parameters 406 via the user interface 400, the user may be presented with a user interface 300 by device 242A illustrated in FIG. 3. In some embodiments, however, the user interface 300 may be presented to the user under other circumstances. The user interface 300 may include one or more presently-selected parameters (e.g., and respective values thereof) 306 (also referred to herein, at times, as selected parameter set 306). Such selected parameter set 306 may have been defined by way of the user interface 400 in FIG. 4, discussed above. In this regard, in some embodiments, the user interface 400 may be accessed by the user upon selection of the “edit” software button 308.

The user interface 300 may indicate a status 304 of the beverage-brewing machine 201A (or other communicatively connected beverage-brewing machine). As discussed above, the beverage-brewing machine 201A may be identified by network address 312, although the invention is not limited to any particular manner of identifying the respective beverage-brewing machine. In some embodiments, the user interface 300 includes a “go” software button 310 which, when engaged by the user, is configured to initiate a beverage-brew-process at the beverage-brewing machine 201A according to the selected parameter set 306. In this regard, in some embodiments, selection of the “go” button 310 causes the data processing device system (e.g., 110) of the device 242A to receive, at step 702 of method 700A in FIG. 7, a user-request, via the input-output device system (e.g., 120, such as via display device 302 and the user interface 300) to perform the beverage-brew-process. In response, the data processing device system of the device 242A may be configured to instruct, via a network-interface device system (e.g., 221, but within device 242A) and the external network 240, the beverage-brewing machine 201A to perform the beverage-brew-process, at step 704 of method 700A.

In some embodiments, the data processing device system (e.g., 110) of the device 242A is configured by a program stored in the memory device system (e.g., 130) of the device 242A to cause the input-output device system (e.g., 120, such as the display device 302 by way of the user interface 300) of the device 242A to display a beverage-related advertisement 314. Such advertisement 314 may be displayed at least when step 702 or step 704 occurs. Such a configuration may present a timely advertisement to the user to purchase a beverage-related product at the moment where the user is intently thinking about drinking the beverage about to be brewed. In some embodiments, at least when the selected parameter set 306 includes at least one adjusted parameter or value thereof, the instruction of step 704 results in the beverage-brewing machine 201A receiving a user-request to at least adjust the at least one beverage-brewing parameter according to step 602 in FIG. 6. At step 604, the beverage-brewing machine 201A (i.e., at least the data processing device system 210 thereof) is configured to adjust the respective beverage-brewing parameter(s) (e.g., the value(s) thereof) in accordance with the at least one adjusted parameter (e.g., the value(s) thereof), according to some embodiments. Upon such adjustment, the beverage-brewing machine 201A (i.e., the data processing device system 210 thereof) may instruct its beverage-brewing device system (e.g., as discussed above with respect to FIG. 2) to perform the beverage-brew-process in a manner consistent with (e.g., according to) the one or more beverage-brewing parameters adjusted in accordance with the user-request, pursuant to step 606 in FIG. 6. For example, if the user adjusted the bloom volume from 25 CC to 30 CC, the beverage-brewing machine 201A (i.e., the data processing device system 210 thereof) may instruct its beverage-brewing device system (e.g., as discussed above with respect to FIG. 2) to perform the beverage-brew-process to have a 30 CC bloom volume. In some embodiments, the data processing device system 210 is configured to monitor the progress of the beverage-brew-process, such as by monitoring an amount of water that has passed through flow controller 225 based on input received from such flow controller 225. In some embodiments, the data processing device system 210 is configured to transmit an indication of the status or progress of the beverage-brew-process to another device, such as remote device 242A.

In this regard, in some embodiments, step 608 in FIG. 6 includes the data processing device system 210 determining that the beverage-brewing device system has completed at least a portion of the beverage-brew-process instructed to be performed at step 606. The data processing device system 210 may be configured to determine that at least a portion of the beverage-brew-process is complete based upon an indication received from the flow controller 225 indicating that a predetermined amount of water has been dispersed. According to step 610, the data processing device system 210 may be configured to transmit, via the network-interface device system 221 and the external network 240, an indication to the remote user-device 242A that the at least the portion of the beverage-brew-process has completed. In some embodiments, the indication transmitted according to step 610 is a text message or an e-mail. In some embodiments, the indication transmitted according to step 610 is transmitted to an address extracted or identified from the user-request received according to step 602. For example, such user-request may include a network address, an e-mail address, or a telephone number identifying the remote device 242A (or other device) as the source of the user-request received by the data processing device system 210 according to step 602. In this regard, the data processing device system 210 may be configured to extract or identify such source-identifying-information from the user-request and incorporate it as the destination address for the indication transmitted according to step 610.

In some embodiments, the transmission according to step 610 results in execution of a method 700C in FIG. 7 by the data processing device system (e.g., 110) of the remote device 242A. The method 700C includes a step 710, at which the data processing device system of the remote device 242A receives, via a network-interface device system (e.g., 221, but within device 242A) and the external network 240, an indication that at least a portion of the beverage-brew-process has completed. At step 712, the data processing device system of the remote device 242A may present, via the input-output device system (e.g., 120, such as display device 302) of the remote device 242A, a notification to the user indicating that the at least the portion of the beverage-brew-process has completed. For example, the status 304 in the user interface 300 may be updated to specify that the beverage-brew-process is completed.

In addition to transmitting a status of the beverage-brew-process, as discussed above at least with respect to step 610 in FIG. 6, the data processing device system 210 is configured, according to step 612 (included in method 600B), to transmit other sensor-based information, according to some embodiments. In some embodiments, a plurality of sensors (e.g., which may include one or more of the sensors 222A, 223A, 224A, 225, 227A, 227B) are communicatively connected to the data processing device system 210 to provide sensor-based information about the beverage-brewing device system (defined, for example, above).

In some embodiments, the data processing device system 210 may be configured to transmit, via the network-interface device system 221 and the external network 240, at least some of this sensor-based information, or a derivative thereof, to a remote device (e.g., remote device 242A) according to step 612. As discussed above with respect to steps 608 and 610, the data processing device system 210 may be configured to extract or identify source-identifying-information from the user-request received at step 600 to and incorporate it as the destination address for the sensor-based information transmitted according to step 612.

In some embodiments, the at least some of the sensor-based information, or the derivative thereof, transmitted according to step 612 indicates whether or not a carafe is properly installed (e.g., pursuant to information from the carafe placement sensor 227A), a water level of the water reservoir 224 (e.g., pursuant to information from the water volume sensor 224A), including whether or not the water reservoir 224 is empty, a water temperature (e.g., pursuant to information from the temperature sensor 223A), a beverage temperature (e.g., pursuant to information from the temperature sensor 227B), a last time that the beverage-brewing machine was used by a user (e.g., pursuant to a determination from the data processing device system 210 of the last time of completion of the beverage-brew-process according to step 608, which may involve information from the flow controller 225), or a last time a portion of the beverage-brewing machine was cleaned (e.g., pursuant to information received from a user by way of a physical button on an external surface of the beverage-brewing machine 201A that is pressed by the user when the user completes a respective cleaning process). It should be noted, however, that the invention is not limited to any particular type of sensor-based information.

In some embodiments, the transmission of the sensor-based information at step 612 leads to initiation of execution of a method 700B at the device 242A. The method 700B may include a step 706 where the data processing device system (e.g., 110) of the device 242A receives, from the beverage-brewing-machine 201A via a network-interface device system (e.g., 221, but within device 242A) and the external network 240, sensor-based information about the beverage-brewing machine 201A. In some embodiments, the method 700B includes a step 708, where the data processing device system of the device 242A presents, via the input-output device system (e.g., 120, such as the display device 302) a notification based on the sensor-based information received at step 706. For example, FIG. 3 illustrates that information 307 from the water volume sensor 224A indicating that the water reservoir 224 contains 4.6 cups of water is presented via display device 302 and the user interface 300. Although FIG. 3 only illustrates water volume information 307, other sensor-based information may be present in addition to or in lieu of such water volume information 307, according to various embodiments.

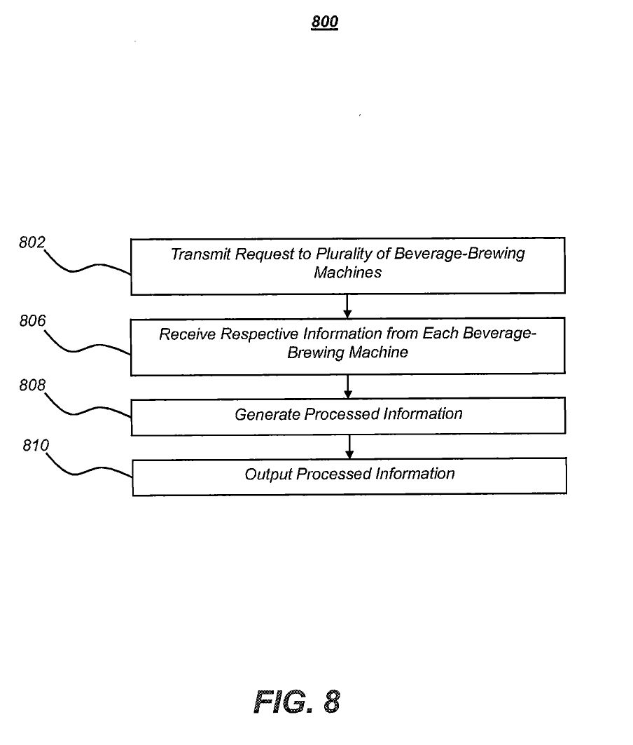

In some embodiments, the beverage-brewing machine 201A transmits information to one or more devices other than remote device 242A. For example, beverage-brew-process status information or other sensor-based information is provided to beverage-brewing machine communication device system, which is represented in FIG. 2, for example, as aggregation device 246, according to some embodiments. The aggregation device 246 may correspond to a particular implementation of the system 100 in FIG. 1. According to some embodiments, the aggregation device 246 is communicatively connected to a plurality of beverage-brewing machines and executes a method 800 illustrated in FIG. 8. FIG. 2 illustrates two examples of the beverage-brewing machines as beverage-brewing machine 201A and beverage-brewing machine 201B, which are illustrated as being communicatively connected to the aggregation device 246 via the external network 240 and respective network-interface device systems (e.g., 221, but in the respective devices 201A, 201B, and 246). However, more than two beverage-brewing machines may be communicatively connected to the aggregation device 246.

At step 802, the data processing device system (e.g., 110) of the aggregation device 246 is configured to transmit a request, via a network-interface device system (e.g., 221, but in the aggregation device 246) and the external network 240, to a plurality of beverage-brewing machines (e.g., 201A, 201B). In response to the transmitted requests, the data processing device system of the aggregation device 246 receives, at step 806, respective information (e.g., at least some of the above-discussed sensor-based information or other information stored by the data processing device system of the respective beverage-brewing machine) from each of the plurality of beverage-brewing machines (e.g., 201A, 201B).

At step 808, the data processing device system of the aggregation device 246 generates process information at least by processing at least some of the respective information received per step 806 from at least two of the plurality of beverage-brewing machines (e.g., 201A, 201B). The aggregation device 246 may output the processed information, or a derivative thereof, via an input-output device system (e.g., 120) of the aggregation device 246 at step 810.

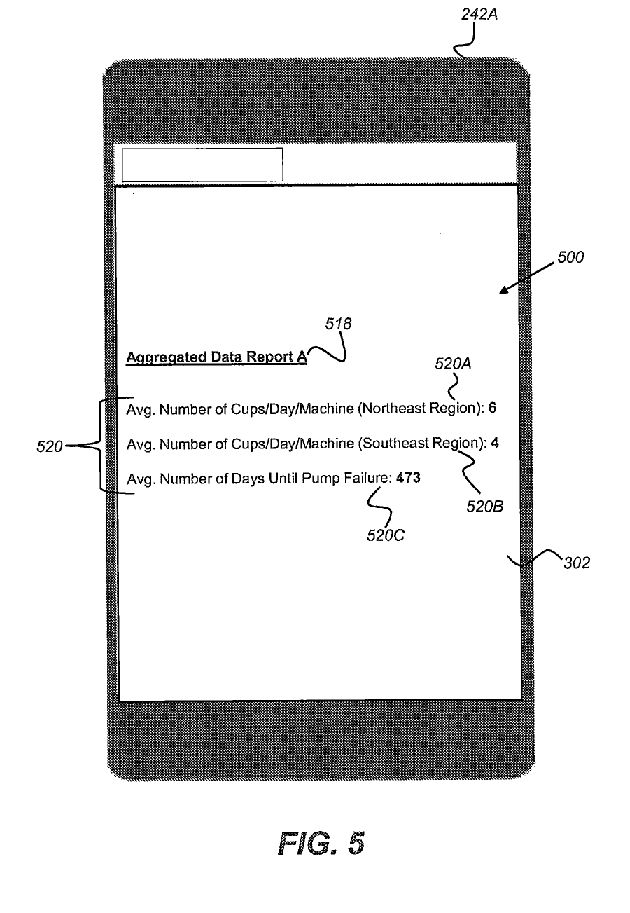

The processing according to step 808 may include aggregating data across multiple beverage-brewing machines to provide high-level information regarding performance of such beverage-brewing machines. For example, FIG. 5 illustrates a display device 302 and user interface 500 of the remote device 242A displaying at least some of the processed information (or a derivative thereof) 520 from step 808, which reflects embodiments where the aggregation device 246 transmits at least some of the processed information from step 808 to such remote device 242A via the external network 240 as part of step 810, in some embodiments. However, the user interface 500 could be presented at the aggregation device 246 or any other device.

In the example of FIG. 5, the user interface 500 illustrates an aggregated data report 518 including processed information 520. In the example of FIG. 5, the processed information 520 includes an average number of cups per day per beverage-brewing-machine in a northeast region 520A, and average number of cups per day per beverage-brewing-machine in a southeast region 520B, and an average number of days until failure of the respective pump 520C (reference 225 in FIG. 2 is an example of a respective pump). Such information 520 may be aggregated based on respective sensor-based information from the respective beverage-brewing machines (e.g., 201A, 201B, etc.). Although FIG. 5 shows averaging as an example of data aggregation, any aggregation performed as part of step 808 may include any combination or summarizing of data.

Subsets or combinations of various embodiments described above provide further embodiments. These and other changes can be made to the invention in light of the above-detailed description and still fall within the scope of the present invention. In general, in the following claims, the terms used should not be construed to limit the invention to the specific embodiments disclosed in the specification. Accordingly, the invention is not limited by the disclosure, but instead its scope is to be determined entirely by the following claims.

What is claimed is:

1. A beverage-brewing machine comprising:
a data processing device system;
a beverage-brewing device system communicatively connected to the data processing device system and configured to perform a beverage-brew-process;
a network-interface device system communicatively connected to the data processing device system and an external network, the external network being external to the beverage-brewing machine; and
a processor-accessible memory device system communicatively connected to the data processing device system and storing a program executable by the data processing device system,
wherein the data processing device system is configured by the program at least to:
receive, from the external network via the network-interface device system, a user-request to at least adjust a beverage-brewing parameter;
adjust the beverage-brewing parameter in accordance with the user-request; and
instruct the beverage-brewing device system to perform the beverage-brew-process in a manner consistent with at least the beverage-brewing parameter adjusted in accordance with the user-request.

2. The beverage-brewing machine of claim 1, wherein the beverage-brewing parameter is a water temperature, a carafe temperature, a timer setting, or a water flow setting.

3. The beverage-brewing machine of claim 2, wherein the beverage-brewing parameter is the water flow setting.

4. The beverage-brewing machine of claim 3, wherein the water flow setting is an adjustable water flow rate over time.

5. The beverage-brewing machine of claim 3, wherein the water flow setting is an adjustable pause in water flow.

6. The beverage-brewing machine of claim 3, wherein the water flow setting is an adjustable volume of water to be released by the beverage-brewing device system.

7. The beverage-brewing machine of claim 1, wherein the user-request is to at least adjust a plurality of beverage-brewing parameters, and wherein the data processing device system is configured by the program at least to:
adjust the plurality of beverage-brewing parameters in accordance with the user-request; and
instruct the beverage-brewing device system to beverage-brew in a manner consistent with at least the plurality of beverage-brewing parameters adjusted in accordance with the user-request.

8. The beverage-brewing machine of claim 7, wherein the plurality of beverage-brewing parameters includes a water temperature, a carafe temperature, a timer setting, and a water flow setting.

9. The beverage-brewing machine of claim 7, wherein the data processing device system is configured by the program at least to store the plurality of beverage-brewing parameters adjusted in accordance with the user-request in the processor-accessible memory device system as a custom mode associated with a user associated with the user-request.

10. The beverage-brewing machine of claim 1, wherein the program comprises a web-server program.

11. The beverage-brewing machine of claim 1, further comprising a plurality of sensors communicatively connected to the data processing device system, the sensors configured to provide sensor-based information about the beverage-brewing device system,
wherein the user-request indicates a remote user-device from which the user-request originated, and
wherein the data processing device system is configured by the program at least to:
transmit, via the network-interface device system and the external network, at least some of the sensor-based information to the remote user-device.

12. The beverage-brewing machine of claim 11, wherein the at least some of the sensor-based information indicates whether or not a carafe is properly installed, a water level of a water reservoir, an empty water reservoir, a water temperature, a carafe heater temperature, a last time the beverage-brewing machine was used by a user, or a last time a portion of the beverage-brewing machine was cleaned.

13. The beverage-brewing machine of claim 1,
wherein the user-request indicates a remote user-device, and
wherein the data processing device system is configured by the program at least to:
determine that the beverage-brewing device system has completed at least a portion of the beverage-brew-process instructed to be performed in the manner consistent with at least the beverage-brewing parameter adjusted in accordance with the user-request; and
transmit, via the network-interface device system and the external network, an indication to the remote user-device that the at least the portion of the beverage-brew-process has completed.

14. The beverage-brewing machine of claim 13, wherein the user-request indicates the remote user-device as a device from which the user-request originated.

15. The beverage-brewing machine of claim 13, wherein the indication to the remote user-device is a text message or an e-mail.

16. The beverage-brewing machine of claim 1, wherein the user-request indicates that a mobile application of a remote and mobile user-device originated the user-request.

17. The beverage-brewing machine of claim 1, wherein the user-request indicates that a web browser of a user-device originated the user-request.

18. A beverage-brewing machine configuration device comprising:
a data processing device system;
an input-output device system communicatively connected to the data processing device system;
a network-interface device system communicatively connected to the data processing device system and an external network, the external network being external to the beverage-brewing machine configuration device; and
a processor-accessible memory device system communicatively connected to the data processing device system and storing a program executable by the data processing device system,
wherein the data processing device system is configured by the program at least to:
receive, via the input-output device system, a user-request to at least perform a beverage-brew-process; and
instruct, via the network-interface device system and the external network, a beverage-brewing machine to perform the beverage-brew-process.

19. The beverage-brewing machine configuration device of claim 18, wherein the data processing device system is configured by the program at least to:
receive, from the beverage-brewing machine via the network-interface device system and the external network, sensor-based information about the beverage-brewing machine.

20. The beverage-brewing machine configuration device of claim 19, wherein the input-output device system comprises a display device, and wherein the data processing device system is configured by the program at least to present, via the display device, a notification based on the received sensor-based information about the beverage-brewing machine.

21. The beverage-brewing machine of claim 19, wherein the sensor-based information indicates whether or not a carafe is properly installed, a water level of a water reservoir, an empty water reservoir, a water temperature, a carafe heater temperature, a last time the beverage-brewing machine was used by a user, or a last time a portion of the beverage-brewing machine was cleaned.

22. The beverage-brewing machine configuration device of claim 18, wherein the data processing device system is configured by the program at least to:
receive, from the beverage-brewing machine via the network-interface device system and the external network, an indication that at least a portion of the beverage-brew-process has completed.

23. The beverage-brewing machine configuration device of claim 18, wherein the data processing device system is configured by the program at least to receive, via the input-output device system, a user-indication of a plurality of beverage-brewing parameters at least for the beverage-brewing machine.

24. The beverage-brewing machine configuration device of claim 22, wherein the data processing device system is configured by the program at least to instruct, via the network-interface device system and the external network, the beverage-brewing machine to store the user-indication of the plurality of beverage-brewing parameters or a derivative thereof

25. The beverage-brewing machine configuration device of claim 22, wherein a particular user is associated with the beverage-brewing machine configuration device, and wherein the data processing device system is configured by the program at least to transmit, via the network-interface device system and the external network, the user-indication of the plurality of beverage-brewing parameters, or a derivative thereof, to at least another beverage-brewing machine configuration device associated with a user previously-approved by the particular user.

26. The beverage-brewing machine configuration device of claim 24, wherein the data processing device system is configured by the program at least to store preferred-parameter information associated with the particular user in the processor-accessible memory device system prior to transmitting the user-indication of the plurality of beverage-brewing parameters, or the derivative thereof, to at least the other beverage-brewing machine configuration device associated with the user previously-approved by the particular user, the preferred-parameter information based on the user-indication of the plurality of beverage-brewing parameters.

27. The beverage-brewing machine configuration device of claim 22, wherein a particular user is associated with the beverage-brewing machine configuration device, and wherein the data processing device system is configured by the program at least to:
instruct, via the network-interface device system and the external network, a remote device system to store preferred-parameter information; and
instruct, via the network-interface device system and the external network, transmission of at least some of the preferred-parameter information stored by the remote device system to at least another beverage-brewing machine configuration device associated with a user previously-approved by the particular user,
wherein the preferred-parameter information is based on the user-indication of the plurality of beverage-brewing parameters.

28. The beverage-brewing machine configuration device of claim 18, wherein the beverage-brewing machine configuration device is a mobile device and the program comprises a mobile application of the mobile device.

29. The beverage-brewing machine configuration device of claim 18, wherein the data processing device system is configured by the program at least to cause the input-output device system to display a beverage-related advertisement at least when (a) receiving the user-request to at least perform the beverage-brew-process, or (b) instructing, via the network-interface device system and the external network, the beverage-brewing machine to perform the beverage-brew-process.

30. The beverage-brewing machine configuration device of claim 1, wherein the beverage-brewing machine is a coffee-brewing machine.

31. A beverage-brewing machine communication device system comprising:
a data processing device system;
an input-output device system communicatively connected to the data processing device system;
a network-interface device system communicatively connected to the data processing device system and an external network, the external network being external to the beverage-brewing machine communication device; and
a processor-accessible memory device system communicatively connected to the data processing device system and storing a program executable by the data processing device system,
wherein the data processing device system is configured by the program at least to:
transmit a request, via the network-interface device system, to each of a plurality of beverage-brewing machines;
receive, in response to the transmitted requests, respective information from each of the plurality of beverage-brewing machines;
generate processed information at least by processing at least some of the respective information received from at least two of the plurality of beverage-brewing machines; and
output, via the input-output device system, the processed information or a derivative thereof

32. The beverage-brewing machine communication device system of claim 31, wherein the processing of the at least some of the respective information received from at least two of the plurality of beverage-brewing machines includes aggregating or summarizing the at least some of the respective information received from at least two of the plurality of beverage-brewing machines.

33. The beverage-brewing machine communication device system of claim 31, wherein the input-output device system comprises a display device, and wherein the output, via the input-output device system, of the processed information is a display of the processed information via the display device.
